(19) United States
(12) Patent Application Publication
(10) Pub. No.: US 2012/0073550 A1
(43) Pub. Date: Mar. 29, 2012

(54) Fuel Metering Device for a Gaseous Fuel Engine

(76) Inventor: Radu Oprea, Bothell, WA (US)

(21) Appl. No.: 13/236,980

(22) Filed: Sep. 20, 2011

Related U.S. Application Data
(60) Provisional application No. 61/386,641, filed on Sep. 27, 2010.

(51) Int. Cl. F02B 43/00

(52) U.S. Cl. 123/527

(57) ABSTRACT

A novel flow control device for metering a preferably gaseous fuel to an internal combustion engine is disclosed.

The innovative flow control device maintains a predetermined air-fuel ratio, while automatically compensating for variations in the energy content of the fuel.

A rotary-flap airflow meter directly drives a preferably butterfly-type main valve, the latter metering a main fuel dose, calibrated to provide an air-fuel ratio slightly leaner than desired, over the entire engine operating domain.

A rotary, or linear, trim valve meters a trim fuel dose, used to additively adjust the mixture to the desired quality.

A drive member, rigidly joined to the rotary air flap, drives said trim valve, through a variable-ratio lever mechanism. The lever fulcrum is linearly moveable, independently of cam position, thereby altering the lever ratio and subsequently, the corrective fuel dose, over a substantially wide flow range.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### REFERENCES

| | | | |
|---|---|---|---|
| 7,418,954 | Iwai | Sep. 2, 2008 | 123/527 |
| 7,395,818 | Fujisawa et al | Jul. 8, 2008 | 123/527 |
| 7,367,312 | Boyer et al | May 6, 2008 | 123/304 |
| 6,810,863 | Memmott et al | Nov. 2, 2004 | 123/527 |
| 6.289,877 | Weisbrod et al | Sep. 18, 2001 | 123/480 |
| 6,226,981 | Bruch et al | May 8, 2001 | 60/274 |
| 6,189,523 | Weisbrod et al | Feb. 20, 2001 | 123/672 |
| 6,178,952 | Lammerts et al | Jan. 30, 2001 | 123/527 |
| 6,176,224 | Wu et al | Jan. 23, 2001 | 123/527 |
| 5,806,490 | Nogi et al | Sep. 15, 1998 | 123/435 |
| 5,720,266 | Nogi et al | Feb. 24, 1998 | 123/680 |
| 5,713,340, | Vanderberghe et al | Feb. 3, 1998 | 123/682 |
| 5,588,416 | Suzuki et al | Dec. 31, 1996 | 123/684 |
| 5,413,075 | Mamiya et al | May 9, 1995 | 123/431 |

### BACKGROUND OF THE INVENTION

Use of gaseous fuels for internal-combustion (IC) engines is widespread, encompassing on-road and industrial engines. The most commonly used gaseous fuels are those based on methane, generically called Natural Gas, or NG, and propane-butane-based mixtures, commonly referred to as Liquefied Petroleum Gas, or LPG.

A typical gaseous fuel application is found on stationary engines, used for power generation, oil and gas pumping, and irrigation.

Regardless of what kind of fuel they burn, IC engines must comply with legislated emissions standards, usually requiring a controller capable of adjusting and maintaining a predetermined air-fuel ratio (subsequently referred to as AFR, throughout this application).

Many engine applications are faced with a variable energy-content of the gaseous fuel, which poses a particularly difficult challenge to the fuel metering device. This is especially true with pumping applications, installed in oil and gas fields, where fuel composition may unpredictably change over time.

The majority of AFR control technologies currently available on the market are tuned for a specific fuel quality (e.g. 90% methane) and perform poorly, or fail, when fuel composition changes substantially.

In most cases, the engine controller is programmed to shut down the engine when the AFR control range has been exceeded, thus preventing the engine from producing high emissions levels, outside of the certified compliance standards. Many engines are installed in remote locations and are difficult to access and repair, making unscheduled shutdowns very undesirable indeed.

Admittedly, some of the currently available control systems do provide some fuel energy compensation means, in the form of a field-adjustable device. However, this method places an additional burden on the engine user, requiring constant monitoring of each engine installation and manual intervention, whenever the system needs to be re-adjusted.

Accordingly, the main objective of the device of this invention is to provide a simple, yet effective fuel control system, with the built-in capability to automatically adapt to a wide range of fuel energy content.

### BRIEF SUMMARY OF THE INVENTION

The device of the invention herein disclosed overcomes the aforementioned disadvantages of the prior art by utilizing a novel fuel metering approach, as follows:

The device of the invention utilizes a rotary-flap airflow meter, in conjunction with two separate fuel-metering valves.

Such momentum-based airflow meters have been widely used, as sensors, to generate an electrical signal, proportional to engine airflow. Perhaps the best-know application has been the Bosch L-Jetronic gasoline fuel injection system.

One of the distinctively novel aspects of the device of the invention is using the rotating air flap to directly drive a physical fuel-metering device, thereinafter referred to as a main valve, as opposed to providing an input to a separate controller. Indeed, the device of the invention uses an airflow meter as an integral part of the fuel metering device.

Another novelty factor is the use of a trim valve, acting in parallel to said main valve and being separately driven by the same rotary air flap, by means of an actuation cam and a drive lever.

As will be clearly explained in the Description and Operation sections of this application, the total fuel quantity required by the engine is split into a main dose and a trim dose. Incoming fuel branches out into a main fuel circuit and a trim fuel circuit, controlled by the main and trim valves, respectively. Metered fuel, from each circuit, discharges into the air stream, downstream of the rotary air flap. The main and trim fuel circuits may merge, downstream of their metering points.

In the preferred embodiment of the invention, schematically illustrated by FIG. 1a and FIG. 1b, both the main and the trim valve are rectangular butterfly-type, i.e. rotary, valves. For clarity, the fuel passageways are removed in FIG. 1a, but shown, in cross-section, in FIG. 1b

Another embodiment, presented in FIG. 2a and FIG. 2b, retains the butterfly valve on the main fuel circuit, but uses a conically shaped linear-travel valve to meter the trim fuel dose. The fuel passageways are again removed in FIG. 2a, but shown, in cross-section, in FIG. 2b.

Each of the two aforementioned embodiments has its own advantages and disadvantages, e.g. the former is potentially easier to build, but the conical valve of the latter affords the capability to seal the trim fuel circuit. In principle, the two embodiments operate very similarly, as succinctly described below:

As depicted by FIG. 1, a and b and FIG. 2, a and b, a rotary air flap directly drives the main valve and indirectly actuates the trim valve, through a cam/lever mechanism.

An actuation cam, rigidly attached to the air flap shaft, moves a variable ratio drive lever, when the air flap rotates. The lever fulcrum can linearly move along a predetermined direction, thereby altering the lever ratio. It is apparent that the angular displacement of the main valve is always same as the angular displacement of the air flap. In contrast, the angular, or linear for the second embodiment, displacement of the trim valve is variable, depending on the drive lever ratio, in turn determined by the fulcrum position.

Engine airflow impinges on the air flap, causing it to rotate, against a return spring. The flap area and return spring tension are calibrated to provide full angular displacement of the flap at maximum engine airflow. A preferably spring-loaded tensioner ensures permanent cam-lever contact is maintained.

FIG. 1 and FIG. 2 only illustrate this preliminary description of the device of the invention. Detailed, captioned, drawings will be introduced in the Description section, and subsequently used for the Description and Operation sections of this application.

Some theoretical considerations are briefly presented below:

The flow area of a butterfly valve area is a function of valve angle, hence the main valve area is a composite function of airflow:

A=α(φ(MAF)) (1)

### Where:

A=main valve flow area;
α=valve angle;
φ=air flap angle;
MAF=airflow.

In order to maintain a constant AFR, with varying airflow, it is imperative to ensure that the fuel-metering area of the main valve linearly tracks airflow, over the entire air flap angular travel. A simple way to obtain a linear area Vs airflow function is to linearize both functions of equation (1). As depicted by FIG. 3, the airflow path is advantageously profiled such as to provide an angular flap displacement, φ, linearly dependent of airflow, MAF.

Similarly, the main fuel passage flow area is a linear function of the butterfly angular position, linearity achieved by the special shape of the valve bore, as shown in FIG. 4.

It is important to note that the flow area of a rectangular butterfly valve, moving in a constant-section rectangular bore, is not a linear function of valve angle. FIG. 5a shows the geometry of such a valve. The flow area, A, can be easily calculated with the equation:

A=WL(1−cos α) (2)

### Where:

A=flow area;
W=width of rectangular butterfly;
L=length of rectangular butterfly;
α=valve angle.

As captured by FIG. 5b, it is possible to linearize the flow area Vs angle function, by profiling each of the two relevant bore walls along a curve described by the equation:

$$y = \pm \frac{L}{2} ( \frac{α}{{α}_{m ax}} + cos α - 1 ) \qquad ( 3 )$$

Where αₘₐₓ=maximum valve angle (90 degrees for any practical application).

FIG. 5c shows the area Vs angle graphs, for both the straight and linear-flow rectangular cross-section bores discussed above.

Thus, the main fuel flow rate is a linear function of airflow, thereby maintaining a constant AFR, irrespective of flap angular position, i.e. over the entire engine operating domain.

The trim valve can also be profiled to provide a linear flow area variation, in respect to valve travel, or stroke. The cam/lever mechanism kinematics does, however introduce some, difficult to eliminate, non-linearity, so the trim valve area is only an approximately linear function of airflow.

With the main and trim valves profiled as explained above, the main fuel dose will be an exactly linear function of airflow, and the corrective fuel dose will be an approximately linear function of airflow, as described by the equations:

\dot{m}_{FM}=α·MAF (4)

\dot{m}_{FC}≈b·MAF (5)

### Where:

\dot{m}_{FM}=Main fuel dose;
\dot{m}_{FC}=Corrective fuel dose;
a=slope of main fuel linear function;
b=slope of corrective fuel linear function;

The AFR, for an arbitrary airflow, MAF is:

$$AFR = \frac{MAF}{{\dot{m}}_{F M} + {\dot{m}}_{FC}} \approx \frac{MAF}{a \cdot MAF + b \cdot MAF} ⇒ AFR \approx \frac{1}{a + b} \qquad ( 6 )$$

While slope a is fixed by the main valve dimensions, slope b can be modified by changing the drive lever fulcrum position, thereby altering the lever ratio. Thus, the trim fuel dose advantageously varies proportional to airflow, the proportionality factor being defined by the drive lever ratio.

For a given lever ratio, the AFR will remain relatively constant during engine transient operation, which is an important advantage of the device of the invention. The device herein disclosed specifically targets stationary engine applications, which operate under, and are regulated for, steady-state conditions, specifically for a constant engine speed. Transient regimes may occur, when engine load changes, while engine speed is continuously governed to a predetermined constant value.

Once the engine load has stabilized, tight AFR control is achieved using a closed-loop control strategy, the feedback signal being supplied by a wideband—or universal—exhaust oxygen sensor, hereinafter referred to as UEGO.

The manipulated variable is the position of the drive lever fulcrum. A preferably electrically-operated actuator linearly moves the fulcrum, altering the lever ratio and subsequently the trim valve position, thereby effectively adjusting the corrective fuel dose to the amount required for providing a predetermined AFR.

It is understood that main fueling is calibrated to always supply a slightly leaner than desired mixture and that trim fuelling is used to additively adjust the mixture to the desired quality. Furthermore, if the main fuelling parameters are tuned for an AFR just lean of desired, with the highest anticipated energy-content fuel, the variable-travel trim valve can be sized to provide enough additional fuel to operate at the same AFR, on the lowest anticipated energy-content fuel.

It should now be apparent that, besides its AFR adjustment function, the trim valve may be advantageously used to compensate for varying fuel energy-content.

Once the desired AFR has been adjusted, within a calibrated deadband around a predetermined value, controller action is no longer required. If the electric actuator is of a type which can hold position when de-energized, e.g. a lead screw design, its position, and subsequently the fulcrum position, will remain unchanged when the actuator is de-energized.

To avoid unnecessarily frequent controller intervention, the control algorithm is designed to only enable the controller during steady-state engine operation, as detected by the air flap motion. Such a strategy will greatly prolong actuator life and is only made possible by the built-in capability of the device to maintain a relatively constant AFR during transients.

### OBJECTS AND ADVANTAGES

Accordingly, several objects and advantages of my invention are:

The main object of the invention is to provide a robust and economically attractive solution for a gaseous fuel metering device, capable to automatically adapt to a wide range of fuel energy-content.

A resulting advantage is the potential for reduced parts inventory, the same device being able to cover a wide range of engine applications.

Yet another advantage is elimination of most of the sensors traditionally used to measure, or to infer, engine airflow, e.g. mass-airflow, or manifold pressure sensors, which are no longer required, since the metering device is also an implicit airflow sensor.

The preferably electrically-driven air-fuel ratio correction actuator of the device is only energized sporadically, when the engine air-fuel ratio deviates from a predetermined set-point, by a certain amount. As long as the air-fuel ratio, as measured by a suitable sensor, falls within a predetermined deadband, the actuator is de-energized, saving energy, compared to full-time on metering devices.

### BRIEF DESCRIPTION OF THE SEVERAL VIEWS OF THE DRAWING

FIG. 1a is a perspective rendering of a preferred embodiment of the invention, revealing the arrangement of the principal components of the device of the invention.

FIG. 1b is another perspective rendering of the preferred embodiment of FIG. 1a revealing the main and trim fuel paths.

FIG. 2a is a perspective rendering of an alternative embodiment of the invention, revealing the arrangement of the principal components of said alternative embodiment of the invention.

FIG. 2b is a different perspective rendering of the alternative embodiment of FIG. 2a, revealing the main and trim fuel paths, specific to this alternative embodiment.

FIG. 3 shows the special air path profile in the device of the invention.

FIG. 4 shows the innovative profile of the main valve bore.

FIG. 5a is a schematic representation of a rectangular butterfly flow area Vs valve angle.

FIG. 5b is a schematic representation of the innovative, linear-flow, butterfly valve bore geometry.

FIG. 5c graphs the flow area functions of the straight bore and linear-flow bore butterfly valves.

FIG. 6 is a detailed description of the preferred embodiment of the invention, introduced in FIG. 1.

FIG. 7 is a detailed description of the alternative embodiment of the invention, introduced in FIG. 2.

FIG. 8a illustrates the operation of the preferred embodiment of the invention, at an arbitrary airflow, and with minimum trim fuel setting.

FIG. 8b illustrates the operation of the preferred embodiment of the invention, at the same arbitrary airflow as in FIG. 8a, but with maximum trim fuel setting.

FIG. 9a illustrates the operation of the preferred embodiment of the invention, at low engine airflow and an arbitrary lever ratio.

FIG. 9b illustrates the operation of the preferred embodiment of the invention, at high engine airflow and same arbitrary lever ratio as in FIG. 9a.

FIG. 10a graphs trim fuel flow as a function of airflow, at minimum and maximum trim flow settings.

FIG. 11a illustrates the operation of the alternative embodiment of the invention, at an arbitrary airflow, and with minimum trim fuel addition.

FIG. 11b illustrates the operation of the alternative embodiment of the invention, at the same arbitrary airflow as in FIG. 11a, and with maximum trim fuel addition.

FIG. 12a illustrates the operation of the alternative embodiment of the invention, at low engine airflow and an arbitrary lever ratio.

FIG. 12b illustrates the operation of the alternative embodiment of the invention, at high engine airflow and same arbitrary lever ratio as in FIG. 12a.

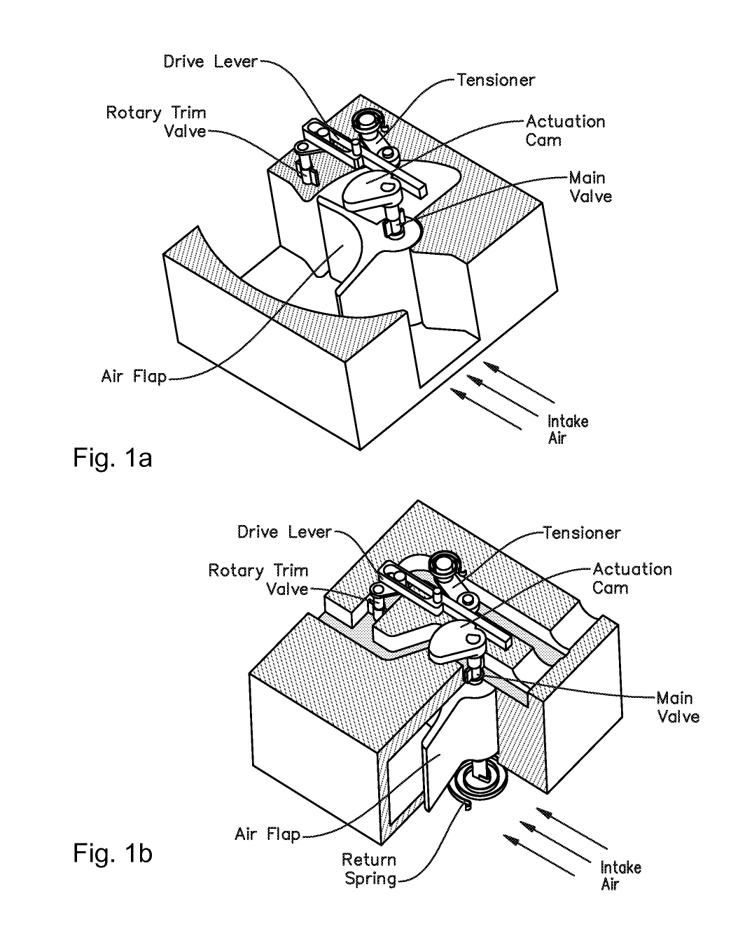

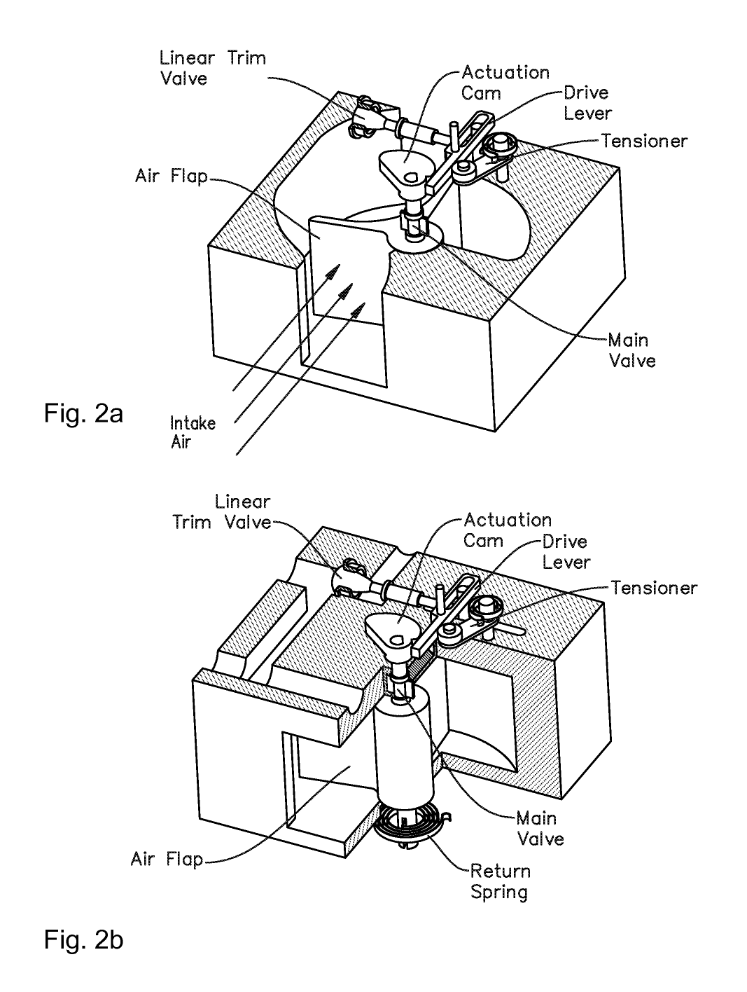

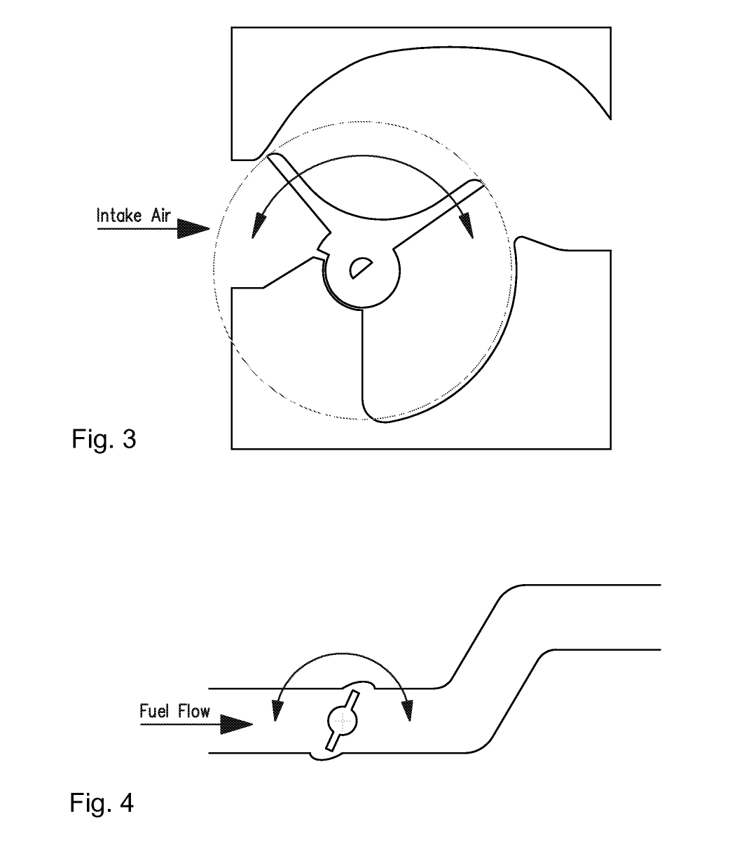

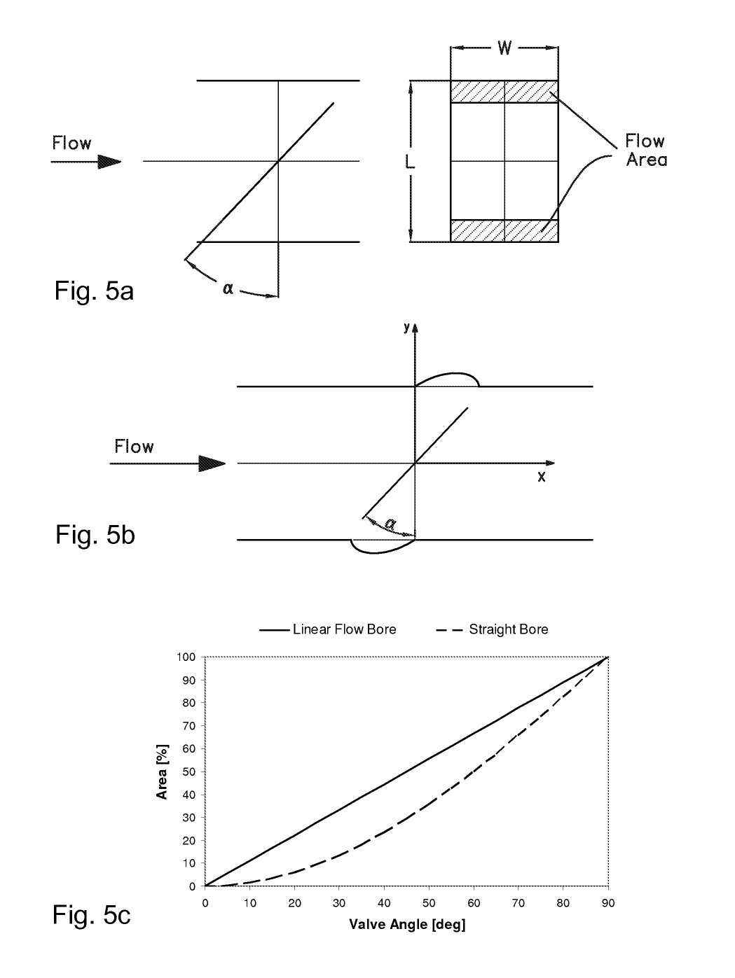

### LIST OF REFERENCE LETTERS AND NUMERALS

5 Housing
5a Air Path
5b Fuel Inlet Passage
5c Main Fuel Passage
5d Trim Fuel Passage
10 Air Flap
10a Leading Surface
20 Return Spring
25 Spring Anchor
30 Main Valve
40 Actuation Cam
50 Rotary Trim Valve
55 Link
56 Slot Follower
57 Linear Trim Valve (visible in alternative embodiment only).
58 Valve Rod (visible in alternative embodiment only).
60 Drive Lever
61 Drive Slot
65 Sliding Fulcrum
70 Tensioner Means
80 Fuel Inlet Fitting
90 Actuator Means
L Linear Path
d1 First Angular Direction
d2 Second Angular Direction
D min Minimum Fulcrum Position
D max Maximum Fulcrum Position
S Linear Valve Travel (visible in alternative embodiment only).

### DETAILED DESCRIPTION OF THE INVENTION

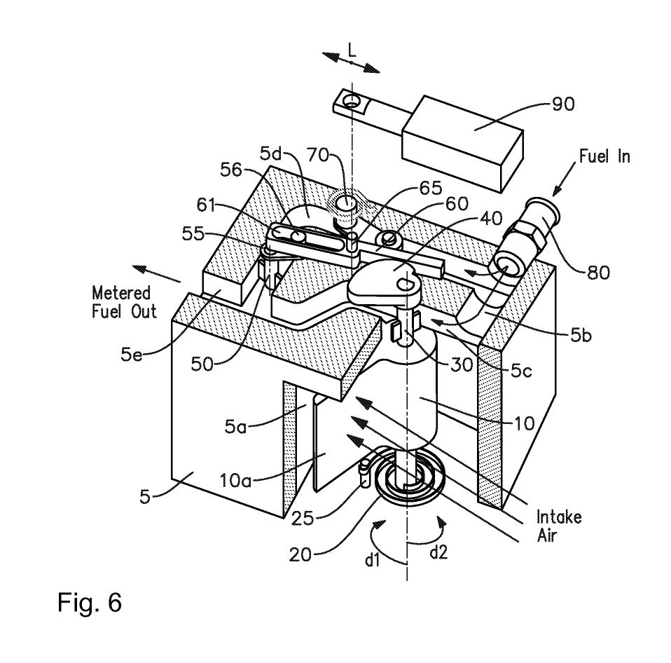

FIG. 6 shows the principal parts of the preferred embodiment of the invention. Components not strictly required to explain the functionality of the device have been removed, for clarity.

A housing 5 is placed in the air intake path of an internal combustion engine. Housing 5 contains an air passage 5a and a fuel inlet passage 5b, machined thereinto. Fuel inlet passage 5b branches out into a main fuel passage 5c and a trim fuel passage 5d.

An air flap 10 is rotatably mounted into housing 5. During engine operation, intake air impinges on the leading surface 10a of air flap 10, causing said air flap to rotate in a first angular direction d1. A return spring 20 is provided, having one end attached to the flap and a second end fixedly attached to an unmovable spring anchor 25. When airflow decreases, or stops, the return spring urges air flap 10 to rotate in a second angular direction d2, substantially opposed said first angular direction d1.

A main valve 30, preferably rectangular in shape and of the butterfly-type, is attached to air flap 10, in a rotationally rigid manner. An actuation cam 40 is similarly mounted to said air flap, whereby both main valve 30 and actuation cam 40 jointly follow the rotary motion of the flap. Main valve 30 controls the flow area of main fuel passage 5c.

A rotary trim valve, 50, preferably rectangular in shape and of the butterfly-type, is rotatably mounted into the housing. Trim valve 50 controls the flow area of trim fuel passage 5d. Trim valve 50 is kinematically connected to actuation cam 40, by means of a link 55 and a drive lever 60. The link has one end rigidly attached to trim valve 50. A slot follower 56 is fixedly attached to the other end of link 55 and said follower is slidably engaged in a drive slot 61, machined into the lever.

Drive lever 60 pivots about a sliding fulcrum 65, which can bidirectionally move along a linear path, L, thereby altering the lever ratio. A preferably spring-loaded tensioner means 70, of a kind well know in the art, maintains permanent contact between actuation cam 40 and the lever. An actuator means 90 has a linearly moveable member, rigidly attached to fulcrum 65, whereby said actuator means can linearly move the fulcrum, to a predetermined position, altering the drive lever ratio.

A gaseous fuel under a predetermined pressure is introduced into fuel inlet passage 5b, through a fuel inlet fitting 80.

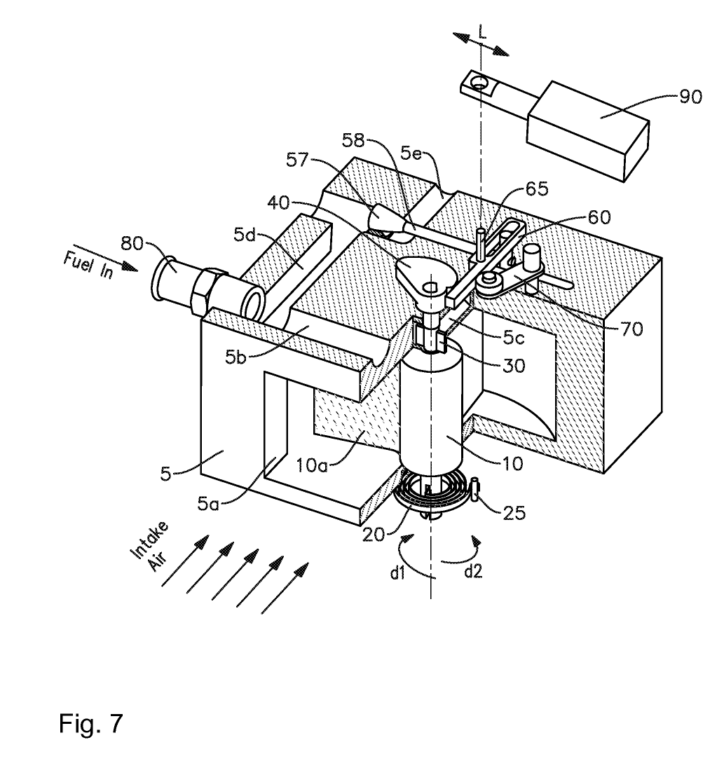

FIG. 7 reveals an alternative embodiment of the invention.

Most components are identical to the preferred embodiment and, unless explicitly stated otherwise, the numerals and corresponding definitions are identical to those in FIG. 6.

The differentiating factor between the preferred and alternative embodiments is the trim valve geometry and kinematics. Indeed, a linear, as opposed to rotary, trim valve, 57, preferably conically-shaped, is slidably mounted into the housing. Linear trim valve 57 controls the flow area of trim fuel passage 5d and is kinematically linked to variable-ratio lever 60 by means of a valve rod 58.

### Operation

Referring now to the preferred embodiment in FIG. 6, incoming air impinges on air leading surface 10a, of air flap 10, causing the flap to rotate about its axis, in said first angular direction d1, against the tension of return spring 20. Under steady-state airflow, the return spring tension balances the pressure force acting on face 10a, holding the flap in a position determined by the point of equilibrium between the two forces. Increasing airflow will move the flap in the direction d1 and decreasing airflow will cause the flap to move in said second angular direction d2, opposite to direction d1, under the action of return spring 25. At zero airflow, the spring urges air flap 10 to an initial position, against a physical stop of a kind well known to those skilled in the art, therefore not explicitly described therein.

A preferably gaseous fuel, at a predetermined pressure, is introduced through fuel inlet fitting 80, into fuel inlet passage 5b. Fuel flow then splits in two, following main fuel passage 5c and trim fuel passage 5d.

Main valve 30 turns jointly with the flap, thereby opening main fuel passage 5c. Air path 5a is shaped such as to cause a linear relationship between flap angular displacement and airflow.

As previously described, main fuel passage 5c is profiled to provide a flow area linearly proportional to the angular displacement of main valve 30. Thus, fuel flow through the main passage is linearly proportional to air flow, thereby maintaining a constant AFR, at any engine operating point.

Actuation cam 40 is attached to air flap 10 in a torsionally rigid manner, therefore turning jointly with the flap. When rotating, the cam causes drive lever 60 to pivot about sliding fulcrum 65, subsequently turning rotary trim valve 50, through link 55 and the slot-follower connection between slot follower 56 and drive slot 61.

Thus, the trim valve opens trim fuel passage 5d, allowing fuel flow therethrough, at a rate proportional to the angular position of rotary trim valve 55.

Uniquely characteristic to the device of the invention, the trim valve angular position can be altered by modifying the ratio of drive lever 60, which is done by translating sliding fulcrum 65 along a predetermined linear path.

Hence, for any given airflow, the main fuel rate remains constant, but the total fuel flow rate can be advantageously adjusted, by altering the trim fuel flow rate. Indeed, when an AFR correction is required, actuator means 80 is energized, moving the lever fulcrum to a predetermined position, along linear path L.

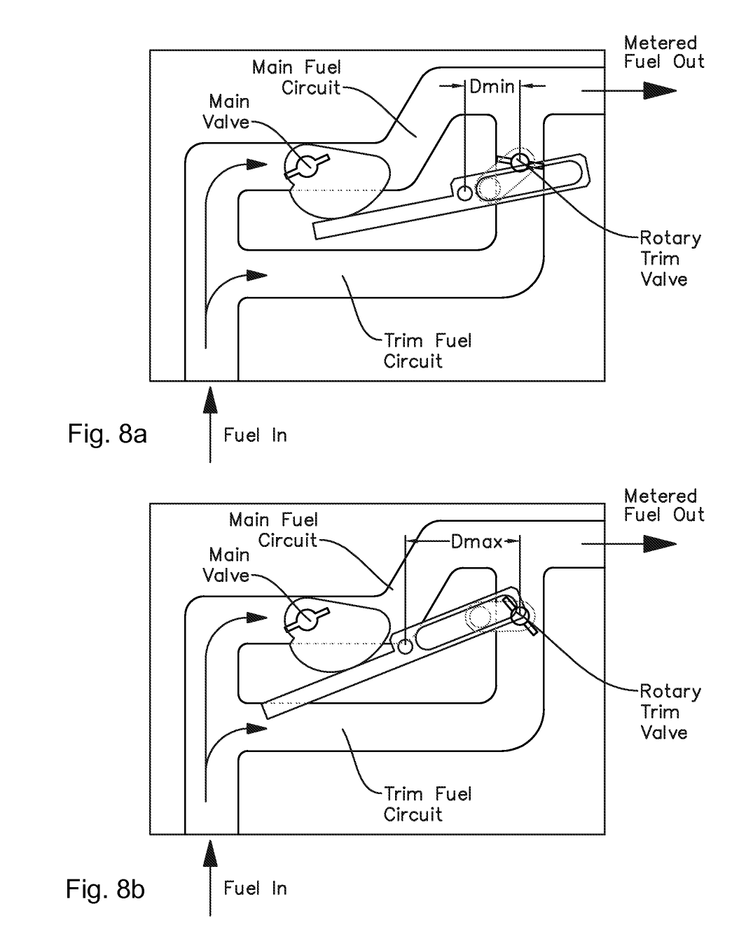

This corrective action can be visualized by examining FIG. 8a and FIG. 8b:

FIG. 8a captures an operating condition, at an arbitrary flow rate, and with minimum trim fuel setting, corresponding to drive lever fulcrum position D min.

FIG. 8b shows the device operating at the same airflow, i.e. same angular position of the main valve, but with maximum trim fuelling, corresponding to drive lever fulcrum position D max. Comparing FIG. 8a to FIG. 8b, it clearly emerges that, for a fixed main valve position, moving the drive lever fulcrum from D min to D max substantially increases the angular travel of the trim valve, and consequently, the trim fuel flow rate.

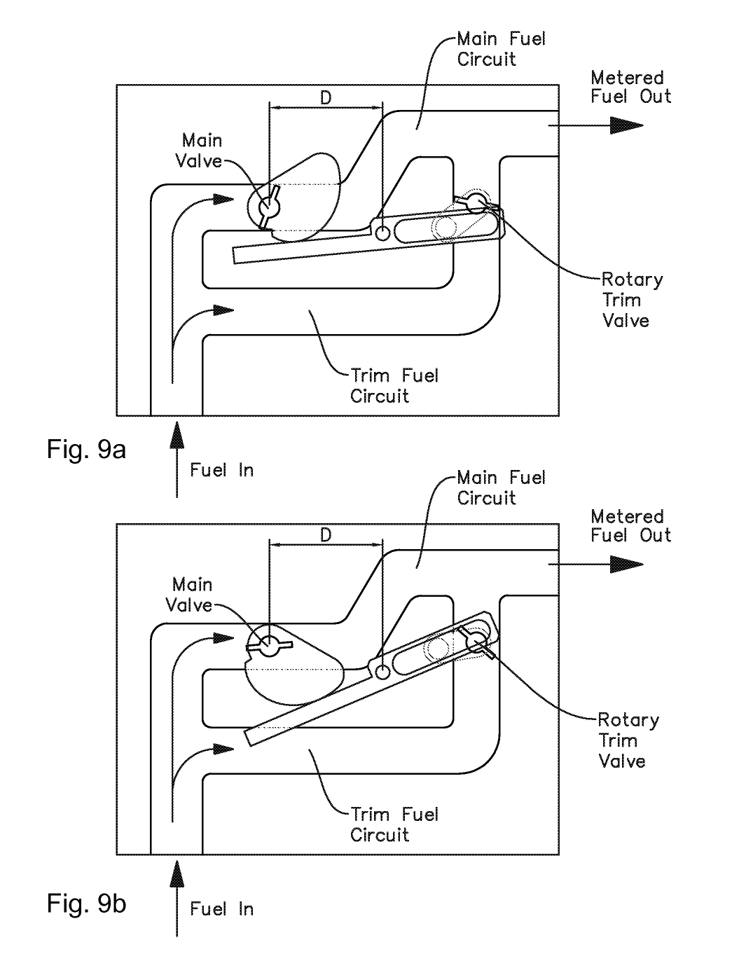

Importantly, once the AFR has been adjusted, for a given operating point, controller action is not required during an engine transient condition, as the trim valve will add fuel in an amount proportional to airflow, as illustrated by FIG. 9, a and b.

The device transitions from low airflow operation, shown in FIG. 9a, to a higher airflow point, in FIG. 9b. The main valve linearly follows the cam motion, caused by the change in airflow. While holding a fixed fulcrum position, D, the rotary trim valve opens by a predetermined amount, as airflow increases.

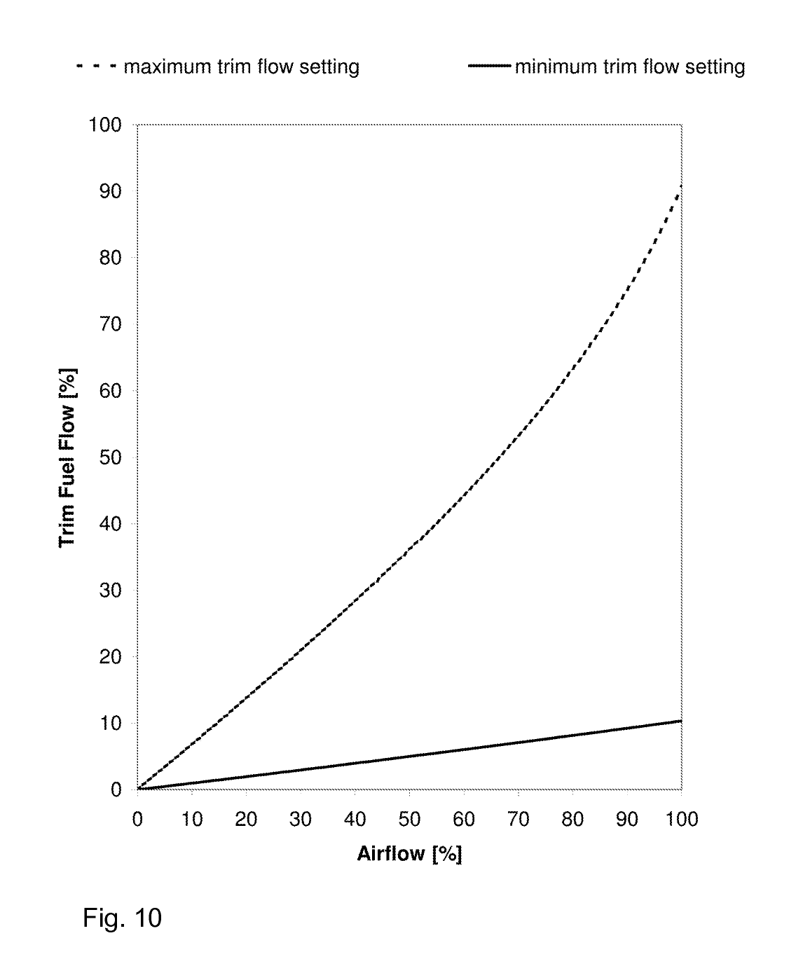

FIG. 10 illustrates trim fuel flow double dependence, on airflow and lever ratio adjustment. The curve labeled “maximum trim flow setting” shows the trim fuel flow rate versus airflow, with the lever ratio adjusted for maximum flow. The other curve, labeled “minimum trim flow setting”, graphs the fuel flow rate versus airflow, with the lever ratio adjusted for minimum flow. The two curves define the trim flow rate envelope, and it is understood that the lever ratio may be adjusted for any flow rate function, within said envelope.

The alternative embodiment in FIG. 7 operates similarly to the preferred embodiment, the main differences being in the trim valve mechanism.

Incoming air impinges on air leading surface 10a, of air flap 10, causing the flap to rotate about its axis, in an angular direction d1, against the tension of return spring 20. Increasing airflow will move the flap in the direction d1 and decreasing airflow will cause the flap to move in the direction d2, opposite to direction d1, under the action of return spring 25.

A preferably gaseous fuel, at a predetermined pressure, is introduced through fuel inlet fitting 80, into fuel inlet passage 5b. Fuel flow then splits in two, following main fuel passage 5c and trim fuel passage 5d.

Main valve 30 turns jointly with the flap, thereby opening main fuel passage 5c. Air path 5a is shaped such as to cause a linear relationship between flap angular displacement and airflow. Main fuel passage 5c is profiled to provide a flow area linearly proportional to the angular displacement of main valve 30. Thus, fuel flow through the main passage is linearly proportional to air flow, thereby maintaining a constant AFR, at any engine operating point.

Actuation cam 40 is attached to air flap 10 in a torsionally rigid manner. When rotating, the cam causes drive lever 60 to pivot about sliding fulcrum 65, imparting a linear motion to valve rod 58 and to linear trim valve 57, rigidly attached to the valve rod.

Thus, the trim valve opens trim fuel passage 5d, allowing fuel flow therethrough, at a rate proportional to the axial position of linear trim valve 57.

The trim valve linear position can be altered by modifying the ratio of drive lever 60, which is done by translating sliding fulcrum 65 along a predetermined linear path.

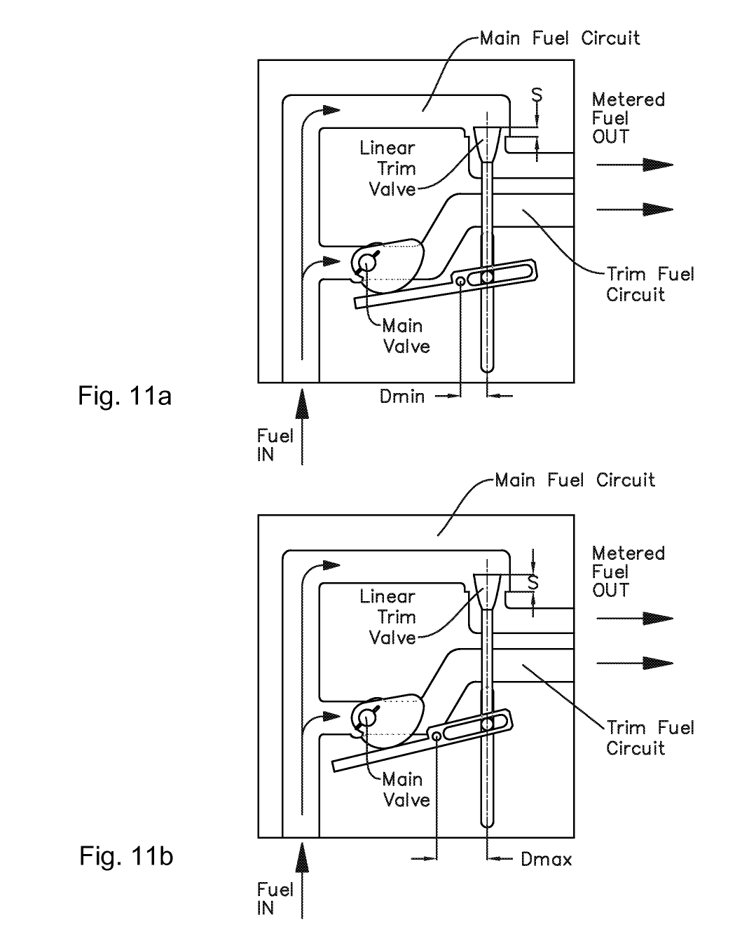

Hence, for any given airflow, the main fuel rate remains constant, but the total fuel flow rate can be advantageously adjusted, by altering the trim fuel flow rate. Indeed, when an AFR correction is required, actuator means 80 is energized, moving the lever fulcrum to a predetermined position, along linear path L. This corrective action can be visualized by examining FIG. 11a and FIG. 11b:

FIG. 11a captures an operating condition, at an arbitrary flow rate, and with minimum trim fuel setting, corresponding to drive lever fulcrum position D min.

FIG. 11b shows the device operating at the same airflow, i.e. same angular position of the main valve, but with maximum trim fuelling, corresponding to drive lever fulcrum position D max. Comparing FIG. 11a to FIG. 11b, it clearly emerges that, for a fixed main valve position, moving the drive lever fulcrum from D min to D max substantially increases the linear travel, S, of the trim valve.

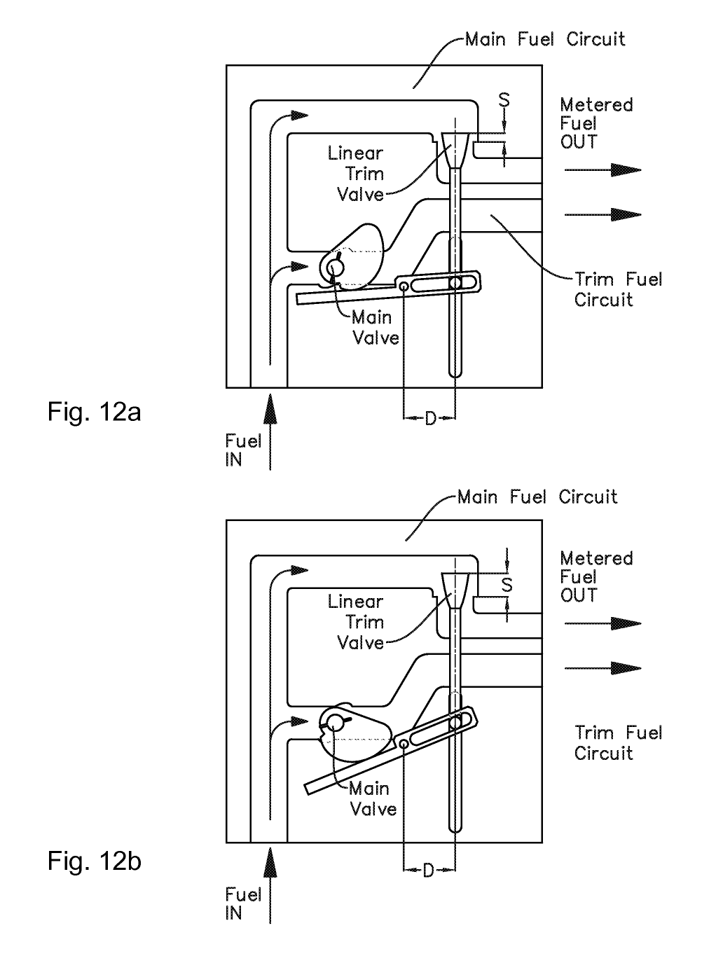

Once the AFR has been adjusted, controller action is not required during an engine transient condition, as the trim valve will add fuel in an amount proportional to airflow, as illustrated by FIG. 12, a and b.

The device transitions from low airflow operation, shown in FIG. 12a, to a higher airflow point, in FIG. 12b. The main valve linearly follows the cam motion, caused by the change in airflow. The change in linear trim valve travel, S, illustrates how, for a fixed fulcrum position, D, the rotary trim valve opens by a predetermined amount, as airflow increases.

The trim fuel flow characteristic envelope, as a function of airflow and drive lever ratio is identical to the one presented in FIG. 10, for the preferred embodiment of the invention.

### CONCLUSION, RAMIFICATIONS AND SCOPE

Thus the reader will see that the fuel system of the invention provides a simple yet effective solution for feeding a precisely metered amount of fuel gas to an internal combustion engine and to automatically adapt to unpredictable changes in the energy content of the fuel.

Accordingly, the scope of the invention should be determined not by the embodiment illustrated, but by the appended claims and their legal equivalents.

I claim:

1. A fuel-metering device, for delivering a predetermined amount of a preferably gaseous fuel to an internal combustion engine, said fuel-metering device comprising:
(a) a housing, placed in the intake air duct of an internal combustion engine, said housing further comprising:
(b) an air passage, said air passage communicating with said intake air duct, whereby engine intake air flows therethrough,
(c) a rotary air flap, rotatably mounted thereinto, said rotary air flap projecting into said air passage, and
(d) a main fuel passage, machined thereinto, wherein said main fuel passage is fluidically connected to a source of gaseous fuel at one end and to a space downstream of the rotary air flap, at the other end, thereby providing a primary fuel flow path, from the gaseous fuel source to the engine,
(e) a main metering valve, attached to said rotary air flap in a rotationally rigid manner, said main metering valve projecting into said main fuel passage, and
(f) said rotary air flap and said main metering valve being free to jointly move in a circular motion, about a common axis of gyration, and
(g) return means, including springs, urging the air flap to a closed position.

2. The fuel-metering device of claim 1 wherein air induced into said internal combustion engine impinges on said rotary air flap, thereby causing the flap to deflect against said return means,
(a) whereby the magnitude of the angular deflection of said rotary air flap is proportional to air flow into the engine, and
(b) whereby said rotary air flap subsequently entrains said main metering valve in a circular motion, about said common axis of gyration.

3. The fuel-metering device of claim 1 wherein said air passage is profiled to render the angular displacement of the flap linearly proportional to airflow.

4. The fuel-metering device of claim 1 wherein said main fuel passage, in combination with said main metering valve define a main flow area, whereby the magnitude of said main flow area is proportional to the valve angular position.

5. The fuel-metering device of claim 4 wherein said main fuel passage is profiled to create a linear relationship between said main flow area and the angular position of said main metering valve, effectively providing a main fuel flow rate linearly proportional to airflow, thereby maintaining a substantially constant air-to-fuel ratio, throughout the entire air flow range.

6. The fuel-metering device of claim 1 further comprising, in combination:
(a) a trim fuel passage, wherein one end of said trim fuel passage is fluidically connected to the space upstream of said main metering valve, and the other end fluidically communicates with the space downstream of said main metering valve, thereby providing a secondary fuel flow path, in parallel to said main flow path, and
(b) a trim valve, moveably mounted into said trim fuel passage.

7. The fuel-metering device of claim 6 wherein said trim valve is embodied by a preferably rectangular rotary valve, rotatably mounted into said trim fuel passage.

8. The fuel-metering device of claim 7 wherein said trim fuel passage, in combination with said rotary valve define a trim flow area, whereby said trim flow area is proportional to the angular position of said rotary valve.

9. The fuel-metering device of claim 7 wherein said trim fuel passage is profiled to provide a linear relationship between said trim flow area and the angular position of said rotary valve.

10. The fuel-metering device of claim 6 wherein said trim valve is embodied by a preferably conical linear valve, slidably mounted into said trim fuel passage.

11. The fuel-metering device of claim 10 further comprising a valve seat, fixedly mounted into the fuel passage.

12. The fuel-metering device of claim 10 wherein said valve seat, in combination with said linear valve, define a trim flow area, whereby said trim flow area is proportional to the linear position of said linear valve.

13. The fuel-metering device of claim 10 wherein the preferably conical trim valve is profiled to provide a linear relationship between said trim fuel flow area and the linear position of said linear valve.

14. The fuel-metering device of claim 6 further comprising, in combination:
(a) a drive member, including a cam, rigidly attached to said rotary air flap, thereby rotating jointly with the flap,
(b) a trim lever, capable of pivoting about a sliding fulcrum, said trim lever being in permanent contact with said drive member at one end and kinematically connected to said trim valve at the other end,
(c) preload means, including springs, for resiliently urging said trim lever in contact with said drive member,
(d) actuator means, capable of linearly moving said sliding fulcrum along a predetermined trajectory,
(e) whereby air flow impinging on the air flap jointly rotates said main metering valve and said drive member, consequently causing said trim lever to rotate about the fulcrum, thereby moving the trim valve to a position determined by the flap angular position and lever ratio, said lever ratio being a function of fulcrum position.

15. The fuel-metering device of claim 14 further comprising a controller, whereby said controller causes said actuator means to translate said sliding fulcrum to a predetermined position, thereby changing the lever ratio, thus altering the position of said trim valve, for a fixed main metering valve position, thereby effectively adjusting the air-fuel ratio to a predetermined value.
